(19) United States
(12) Patent Application Publication
(10) Pub. No.: US 2009/0320651 A1
(43) Pub. Date: Dec. 31, 2009

(54) Valve handle turning tool and method of use

(76) Inventor: Bruce Elliot Kramer, Potomac, MD (US)

Correspondence Address: BRUCE E. KRAMER, 9112 CHERBOURG DR., POTOMAC, MD, 20854, US

(21) Appl. No.: 12/457,826

(22) Filed: Jun. 23, 2009

Related U.S. Application Data
(60) Provisional application No. 61/129,478, filed on Jun. 30, 2008.

(51) Int. Cl. B25B 13/48; B25B 23/16; B25B 13/54; B25B 13/06

(52) U.S. Cl. 81/176.2; 81/124.7; 81/177.2; 137/1

(57) ABSTRACT

A valve handle turning tool includes a tool handle having at one end thereof a head which is specifically designed to engage a valve handle so that the valve handle can be turned. A method for turning a valve handle to open or close a valve includes fitting a valve handle turning tool over a valve handle and moving the tool to turn the valve handle to open or close the valve, wherein the valve handle turning tool is a valve handle turning tool including a tool handle having at one end thereof a head which is specifically designed to engage a valve handle so that the valve handle can be turned.

### CROSS-REFERENCE TO RELATED APPLICATIONS

This application claims benefit of U.S. Provisional Application No. 61/129,478 filed Jun. 30, 2008, the disclosure of which is incorporated herein by reference.

### FIELD OF THE INVENTION

The present invention is directed to a tool designed to help a person turn the handle of a valve on a water line, e.g., for a hose hook-up on the outside of a house, as well as to a method for turning a valve handle through the use of the tool.

### BACKGROUND OF THE INVENTION

A valve handle on a water line can be difficult to turn, particularly for a person with arthritis or for a person who lacks sufficient strength to turn such a valve handle. Since such a person may have a need to turn such a valve handle (e.g., to water the lawn at that person's house), it is an object of the present invention to provide that person with a tool designed to help turn the valve handle.

### SUMMARY OF THE INVENTION

To satisfy the above object and other objects, the present invention provides the following:

1. A valve handle turning tool comprising a tool handle having at one end thereof a head which is specifically designed to engage a valve handle so that the valve handle can be turned.

2. A valve handle turning tool as in tool 1 above, wherein the head has an indented section sized and shaped to engage the valve handle so that the valve handle can be turned.

3. A valve handle turning tool as in tool 2 above, wherein the indented section can engage a valve handle having a shape of a star with six rounded points.

4. A valve handle turning tool as in tool 1 above, wherein the head has an opening sized and shaped to engage the valve handle so that the valve handle can be turned.

5. A valve handle turning tool as in tool 4 above, wherein the opening can engage a valve handle having a shape of a star with six rounded points.

6. A valve handle turning tool as in tool 1 above, wherein the head has a protruding section sized and shaped to engage the valve handle so that the valve handle can be turned.

7. A valve handle turning tool as in tool 6 above, wherein the protruding section can engage a valve handle having a shape of a star with six rounded points.

8. A valve handle turning tool as in tool 1 above, wherein the head has prongs extending out from the head which are positioned and sized to engage the valve handle so that the valve handle can be turned.

9. A valve handle turning tool as in tool 8 above, comprising six prongs positioned to engage a valve handle having a shape of a star with six rounded points.

10. A valve handle turning tool as in tool 1 above, wherein the tool handle is a telescoping handle.

11. A method for turning a valve handle to open or close a valve, comprising fitting a valve handle turning tool over a valve handle and moving the tool to turn the valve handle to open or close the valve,

wherein the valve handle turning tool is a valve handle turning tool as in tool 1 above.

12. A method as in method 11 above, wherein the head has an indented section sized and shaped to engage the valve handle so that the valve handle can be turned.

13. A method as in method 12 above, wherein the indented section can engage a valve handle having a shape of a star with six rounded points.

14. A method as in method 11 above, wherein the head has an opening sized and shaped to engage the valve handle so that the valve handle can be turned.

15. A method as in method 14 above, wherein the opening can engage a valve handle having a shape of a star with six rounded points.

16. A method as in method 11 above, wherein the head has a protruding section sized and shaped to engage the valve handle so that the valve handle can be turned.

17. A method as in method 16 above, wherein the protruding section can engage a valve handle having a shape of a star with six rounded points.

18. A method as in method 11 above, wherein the head has prongs extending out from the head which are positioned and sized to engage the valve handle so that the valve handle can be turned.

19. A method as in method 18 above, comprising six prongs positioned to engage a valve handle having a shape of a star with six rounded points.

20. A method as in method 11 above, wherein the tool handle is a telescoping handle.

### BRIEF DESCRIPTION OF THE DRAWINGS

FIG. 1 shows a typical valve handle.

FIG. 2 shows a tool of the invention with an indented section or opening.

FIG. 3 shows a tool of the invention with a protruding section.

FIG. 4 shows a tool of the invention with prongs.

### DETAILED DESCRIPTION OF THE INVENTION

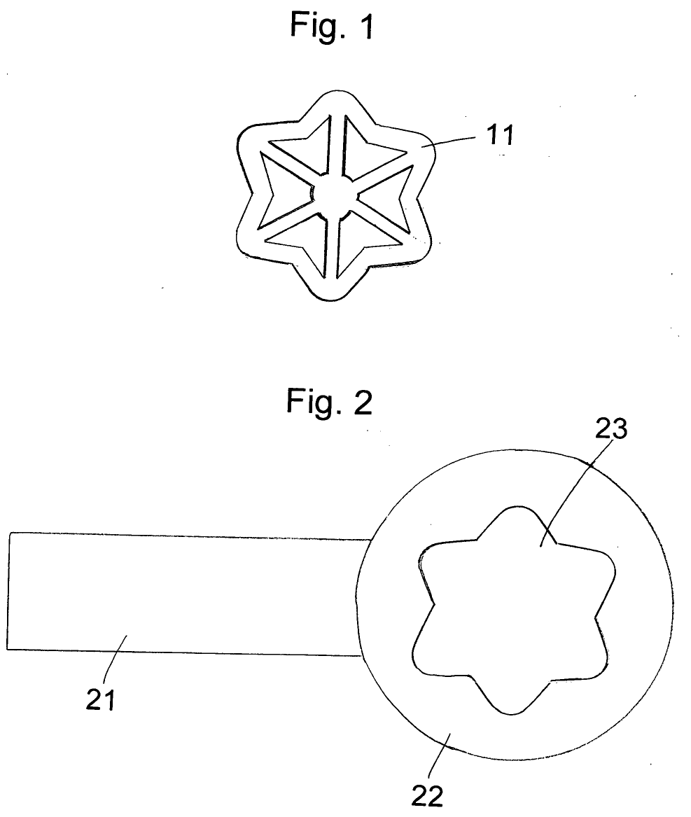

The tool of the present invention is like a wrench and is specifically designed to enable its user to turn a valve handle (FIG. 1 shows a typical valve handle 11).

One tool of the present invention is shown in FIG. 2, in which the tool includes a tool handle 21 having at one end a head 22 including an indented section or opening 23.

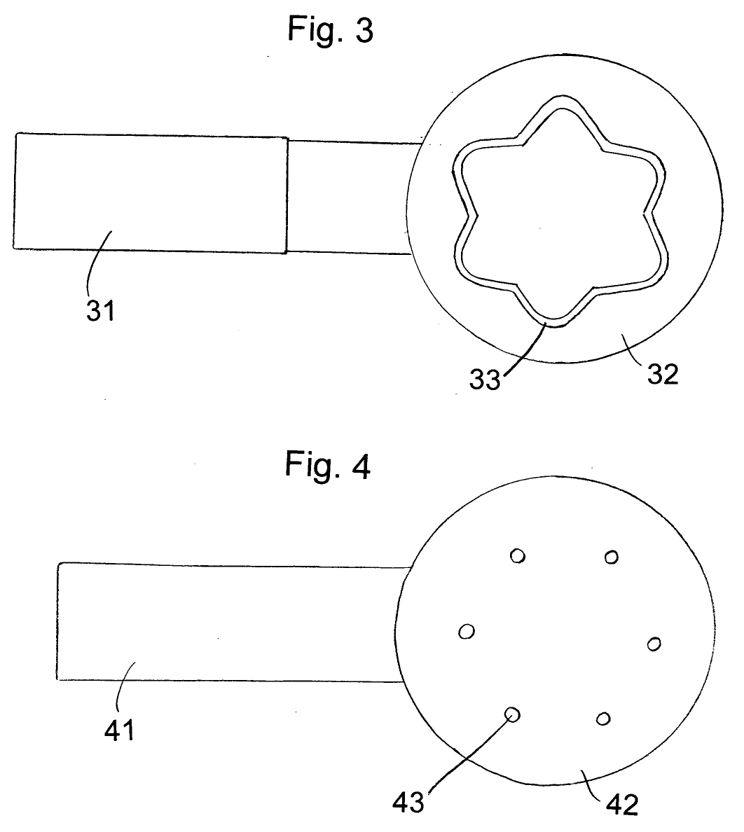

Another tool of the present invention is shown in FIG. 3, in which the tool includes a telescoping tool handle 31 having at one end a head 32 including a protruding section 33.

Yet another tool of the present invention is shown in FIG. 4, in which the tool includes a tool handle 41 having at one end a head 42 including prongs 43.

The various aspects of the tool will now be described in greater detail.

The tool has at least a handle (the tool handle) and a head which is attached to one end of the tool handle and which is specifically designed to engage (fit over) a valve handle so that the valve handle can be turned. The tool can be made of metal, plastic, wood, or any other suitable material, or a combination thereof. Metal (e.g., steel) is preferred for purposes of making the tool strong and durable, and plastic is preferred for making the tool lightweight and easy to use.

The tool handle can be a one-piece handle, such as the one shown in, e.g., FIG. 2, or a telescoping handle, such as the one shown in FIG. 3 (telescoping in the same manner as an antenna on a television set). A telescoping handle can make the tool compact for storage when the tool handle is not extended and can make a valve handle easier to turn when the tool handle is extended.

The tool handle can be any size appropriate to enable a person to turn a valve handle. For example, the tool handle could be 6 to 12 inches long, optionally telescoping to up to 2 feet long.

The head can be attached to one end of the tool handle by being part of the same piece of material (e.g., when the tool handle is not a telescoping handle, the tool including the tool handle and head can be manufactured as a single piece) or by being fastened (e.g., the tool handle could be screwed into the head). For example, a second tool handle could be screwed into a head already having one tool handle attached thereto in order to provide tool handles to be held by both hands of the person using the tool (the tool handles could be at opposite sides of the head).

In one embodiment of the head, the head can have an indented section sized and shaped to engage the valve handle so that the valve handle can be turned (see FIG. 2). The depth of the indented section could be, e.g., about 0.5 inch to about 1 inch. The shape of the indented section corresponds to the shape of the valve handle to be turned. For example, a typical valve handle is in the form of a star with six rounded points (or a hexagon with six rounded protrusions, one at each corner of the hexagon), so a typical indented section would be designed to fit over and engage the valve handle so the valve handle could be turned.

In a second embodiment of the head, the head can have an opening sized and shaped to engage the valve handle so that the valve handle can be turned (see FIG. 2). The depth of the opening could be, e.g., about 0.5 inch to about 1 inch. The shape of the opening corresponds to the shape of the valve handle to be turned. For example, a typical valve handle is in the form of a star with six rounded points (or a hexagon with six rounded protrusions, one at each corner of the hexagon), so a typical opening would be designed to fit over and engage the valve handle so the valve handle could be turned.

In a third embodiment of the head, the head can have a protruding section sized and shaped to engage the valve handle so that the valve handle can be turned (see FIG. 3). The height of the protruding section could be, e.g., about 0.5 inch to about 1 inch. The protruding section should have a wall thickness which is thick enough (e.g., about 0.125 inch to about 0.25 inch) so that the protruding section does not become bent after repeated use. The shape of the protruding section corresponds to the shape of the valve handle to be turned. For example, a typical valve handle is in the form of a star with six rounded points (or a hexagon with six rounded protrusions, one at each corner of the hexagon), so a typical protruding section would be designed to fit over and engage the valve handle so the valve handle could be turned.

In a fourth embodiment of the head, the head can have prongs (posts or pins) extending out from the head, desirably in a perpendicular direction, positioned and sized to engage the valve handle so that the valve handle can be turned (see FIG. 4). The length (height) of the prongs could be, e.g., about 0.5 inch to about 2 inches. For instance, the prongs could be about 1 inch long. The positioning of the prongs corresponds to an arrangement which can engage the valve handle to be turned. For example, a typical valve handle is in the form of a star with six rounded points (or a hexagon with six rounded protrusions, one at each corner of the hexagon), so a typical set of prongs would be six prongs designed to fit over and engage the valve handle so the valve handle could be turned. If the valve handle has interior openings like the valve handle shown in FIG. 1, the prongs could be positioned to fit into the interior openings, if desired.

While the tool has been described in specific embodiments regarding engaging a typical valve handle in the form of a star with six rounded points (or a hexagon with six rounded protrusions, one at each corner of the hexagon), other specific embodiments of the tool can be used to engage different types of valve handles. For example, if the valve handle is simply a bar shape, the tool could have four prongs designed to fit over and engage the valve handle so the valve handle could be turned (e.g., the four prongs could correspond to the four corners of a rectangle defined by lines connecting the four prongs).

In another aspect of the present invention, each of the heads in the above-mentioned four embodiments can be fitted like a socket on a socket wrench desirably with a ratchet handle (a ratchet wrench).

The tool of the present invention can be made in the same manner as a typical wrench. For example, the tool of the present invention can be made from a metal which is forged or cast. Alternatively, the tool of the present invention can be made from plastic which is injection molded.

The tool of the present invention can be used by fitting the head of the tool over the valve handle and then moving the tool handle to turn the valve handle to open or close the valve as desired. The valve handle may be on an outside water line (e.g., for a hose hook-up on the outside of a house) or on an inside water line (e.g., for a hook-up to a washing machine or for water shut-off valve). The tool of the present invention makes it easier to turn a valve handle which is difficult to turn, particularly for a person with arthritis or for a person who lacks sufficient strength to turn such a valve handle. The tool of the present invention also makes it easier and safer to turn a valve handle which is difficult to reach, such as a valve handle high on a wall or near the ceiling in a basement, whereby a person using the tool would no longer need to stand on a step ladder or a chair to turn the valve handle.

While the invention has been described in detail and with reference to specific embodiments thereof, it will be apparent to one of ordinary skill in the art that various changes and modifications can be made therein without departing from the spirit and scope thereof.

What is claimed is:

1. A valve handle turning tool comprising a tool handle having at one end thereof a head which is specifically designed to engage a valve handle so that the valve handle can be turned.

2. A valve handle turning tool as in claim 1, wherein the head has an indented section sized and shaped to engage the valve handle so that the valve handle can be turned.

3. A valve handle turning tool as in claim 2, wherein the indented section can engage a valve handle having a shape of a star with six rounded points.

4. A valve handle turning tool as in claim 1, wherein the head has an opening sized and shaped to engage the valve handle so that the valve handle can be turned.

5. A valve handle turning tool as in claim 4, wherein the opening can engage a valve handle having a shape of a star with six rounded points.

6. A valve handle turning tool as in claim 1, wherein the head has a protruding section sized and shaped to engage the valve handle so that the valve handle can be turned.

7. A valve handle turning tool as in claim 6, wherein the protruding section can engage a valve handle having a shape of a star with six rounded points.

8. A valve handle turning tool as in claim 1, wherein the head has prongs extending out from the head which are positioned and sized to engage the valve handle so that the valve handle can be turned.

9. A valve handle turning tool as in claim 8, comprising six prongs positioned to engage a valve handle having a shape of a star with six rounded points.

10. A valve handle turning tool as in claim 1, wherein the tool handle is a telescoping handle.

11. A method for turning a valve handle to open or close a valve, comprising fitting a valve handle turning tool over a valve handle and moving the tool to turn the valve handle to open or close the valve,
wherein the valve handle turning tool is a valve handle turning tool as in claim 1.

12. A method as in claim 11, wherein the head has an indented section sized and shaped to engage the valve handle so that the valve handle can be turned.

13. A method as in claim 12, wherein the indented section can engage a valve handle having a shape of a star with six rounded points.

14. A method as in claim 11, wherein the head has an opening sized and shaped to engage the valve handle so that the valve handle can be turned.

15. A method as in claim 14, wherein the opening can engage a valve handle having a shape of a star with six rounded points.

16. A method as in claim 11, wherein the head has a protruding section sized and shaped to engage the valve handle so that the valve handle can be turned.

17. A method as in claim 16, wherein the protruding section can engage a valve handle having a shape of a star with six rounded points.

18. A method as in claim 11, wherein the head has prongs extending out from the head which are positioned and sized to engage the valve handle so that the valve handle can be turned.

19. A method as in claim 18, comprising six prongs positioned to engage a valve handle having a shape of a star with six rounded points.

20. A method as in claim 11, wherein the tool handle is a telescoping handle.
